(19) United States
(12) Patent Application Publication
(10) Pub. No.: US 2015/0305345 A1
(43) Pub. Date: Oct. 29, 2015

(54) Compositions and Methods for Controlling Algae Growth

(71) Applicant: United Chemical Corp., Piru, CA (US)

(72) Inventor: Scott Hamilton, Santa Paula, CA (US)

(21) Appl. No.: 14/687,724

(22) Filed: Apr. 15, 2015

Related U.S. Application Data
(60) Provisional application No. 61/983,334, filed on Apr. 23, 2014.

(51) Int. Cl. A01N 59/00; C02F 1/50

(52) U.S. Cl. CPC A01N 59/00; C02F 1/50; C02F 2303/04

(57) ABSTRACT

Compositions and methods are described that provide control of unwanted algae growth in enclosed bodies of water, such as swimming pools and spas, without the need for added chlorinating and/or oxidizing agents. The composition includes a bromine-containing salt and can be applied on an as needed basis, without the need for testing of the water chemistry.

This application claims the benefit of U.S. Provisional Patent Application No. 61/983,334, filed on Apr. 23, 2014. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is control of algae growth, particularly control of algae growth in swimming pools and spas.

### BACKGROUND

The background description includes information that may be useful in understanding the present invention. It is not an admission that any of the information provided herein is prior art or relevant to the presently claimed invention, or that any publication specifically or implicitly referenced is prior art.

Chemical agents are commonly used in swimming pools and spas in order to prevent undesirable algal growth, often with only limited success. Examples of such chemical agents include chlorine and compounds that decompose to generate chlorine, ozone, metal compounds and salts (for example, copper and/or silver), and herbicides (such as Simazine®). Unfortunately, over time microorganisms such as algae can adapt to the presence of such chemical agents and grow in enclosed bodies such as swimming pools and spas despite aggressive treatment.

It has been found that bromine in the form of Br₂ can act as an effective anti-microbial agent that prevents the growth of algae. For example, U.S. Pat. No. 6,120,698 (to Rounds and Hsu) discloses a biocidal water treatment formulation that includes Br₂ (i.e. elemental bromine) in addition to buffering agents and oxidizers. Elemental bromine, however, requires special handling as it is a caustic liquid that evaporates to form a hazardous gas under ambient conditions. Other approaches have been developed that generate Br₂ in situ. International Patent Publication WO 00/58532 (to Yang et al) describes a method that generates Br₂ from a stabilized bromine source using an oxidizer at extremely high pH (at least 13), however such a method is not suitable for batch treatment of swimming pools. In other examples of in situ Br₂ generation, U.S. Pat. No. 4,846,979 (to Hamilton) and U.S. Pat. No. 5,254,526 (to Hamilton) discloses the use of compositions that include bromine containing salts to control algae growth, however it is necessary to generate the active Br₂ species from the bromine salt by adding an oxidizing agent (for example, chlorine or hypochlorite) to the treated body of water.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for a safe and effective algaecide preparation that does not require the use of an oxidizing agent.

### SUMMARY OF THE INVENTION

Compositions and methods of the inventive concept provide effective control of algae growth in enclosed bodies of water, such as pools and spas, through the application of a composition that includes a bromide salt, and does not require the use of an oxidizing agent.

Embodiments of the inventive concept include an algaecide composition that contains a bromide salt, sulfamic acid or a sulfamate salt, and, a borate salt. The bromide salt is present in excess over the other components. For example, in some embodiments the bromide salt is present in a 2.5 fold or greater molar excess over the sulfamic acid the sulfamate salt. Similarly, in such embodiments the bromide salt is present in a 20 fold or greater molar excess over the borate salt. Typical bromide salts that are useful in the composition include sodium bromide, ammonium bromide, and potassium bromide.

Such an algaecide composition can include other ingredients. For example a buffer (such as a phosphate salt) in included in some embodiments. Useful buffers include a sodium phosphate salt selected from the group consisting of sodium hexametaphosphate, disodiumphosphate, and tetrasodium phosphate. Similarly, the algaecide composition includes an oxidizing agent in some embodiments, although it is not needed for the algaecidal effect. Suitable oxidizing agents include ozone, chlorine, hypochlorite containing salts, dicholoroisocyanurate salts, dichloro-S-triazinetrione dihdrate, trichloro-S-triazinetrione, peroxides, and perborate salts. In some embodiments, the algaecide composition can also include a colorant, such as a dye. In such embodiments the dye can be blue, which aids in determining that the water has been treated and can serve as an indicator of the extent of treatment.

Another embodiment of the inventive concept is a method of controlling algae growth in an enclosed body of water, such as a swimming pool or spa. In such a method an algaecide composition, as described above, is added to an enclosed body of water (such as a swimming pool, hot tub, or spa) in an amount that provides at least about 0.5 ppm of bromide once the composition is dissolved. In a preferred embodiment, such an addition is sufficient to control algae growth for at least a week. In some embodiments the composition includes a colorant, and treatment levels can be determined by observing the colorant in the treated water. Although it is not necessary for the algaecidal effect, methods of the inventive concept include adding an oxidizing agent (such as ozone, chlorine, a hypochlorite containing salt, a dicholoroisocyanurate salt, dichloro-S-triazinetrione dihdrate, trichloro-S-triazinetrione, a peroxide, and/or a perborate salt) to the enclosed body of water. In some embodiments of the inventive concept, the method also serves to control the buildup of scale.

### DETAILED DESCRIPTION

The inventive subject matter provides a composition that prevents undesirable algal growth when added to a body of water, for example an enclosed swimming pool or spa. The composition provides a source of Br₂ without the need for additional oxidizing agents, so that testing of the treated water is not required.

Various objects, features, aspects and advantages of the inventive subject matter will become more apparent from the following detailed description of preferred embodiments, along with the accompanying drawing figures in which like numerals represent like components.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One should appreciate that the disclosed compositions and methods provide many advantageous technical effects including safe and convenient control of the growth of unwanted algae without the need to provide carefully measured and controlled doses of an additional oxidizing agent, obviating the need to test either pre-treatment or post-treatment water. In addition, when used in pools and spas a reduced concentration of potentially irritating oxidizing agents commonly used to control microbial growth, for example chlorine and chlorine compounds, can be utilized.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Compositions of the inventive concept can include a source of bromine, for example a bromine containing compound or salt. Such bromine containing compounds or salts are at least partially water soluble, and include ammonium salts and alkaline metal salts. Such salts can provide a safe and stable bromine-containing component that does not require special handling or the use of stabilizers. In a preferred embodiment the bromine containing compound or salt is sodium bromide, potassium bromide, ammonium bromide, or a combination of these. Such bromine containing compounds or salts can be present as a component of a liquid solution or as a solid in a mixture of solids, in amounts appropriate to control algal growth. Surprisingly, compositions of the inventive concept have been found to provide effective algae control without the addition of or need to use an oxidizing agent. This advantageously permits their use without the need for chemical testing of the treated water. It should be appreciated, however, that compositions of the inventive concept are compatible with the use of an added oxidizing agent (for example ozone, chlorine, a hypochlorite containing salt, and/or other chlorine-containing or chlorine-generating salts or compounds).

Compositions of the inventive concept can also include compounds that enhance aspects of swimming pool and spa water chemistry that are not directly related to algae growth. For example, a composition of the inventive concept can include a descaling compound, for example sulfamic acid. Similarly, such a composition of the inventive concept can include a buffering compound, for example borax, sodium borate, sodium tetraborate, disodium tetraborate, and/or other boron containing salts/compounds, sodium hexametaphosphate, disodium phosphate, monosodium phosphate, trisodium phosphate, and/or tetrasodium phosphate, and/or other phosphate containing salts. In some embodiments, compositions of the inventive concept include both borate salts and phosphate salts.

In some embodiments the composition includes a dye or other colorant, which can serve to tint the water and enhance the esthetics of a pool or spa. Such a dye or colorant can also serve as a visual indicator that such a body of water has been treated with an algaecide of the inventive concept, and to aid in product identification by a user. Such dyes or colorants can be any suitable color. In a preferred embodiment the dye or colorant is a blue dye.

In some embodiments, a composition of the inventive concept can include an oxidizing agent, for example sodium dicholoroisocyanurate, dichloro-S-triazinetrione dihdrate, trichloro-S-triazinetrione, and other compounds that decompose to generate chlorine on dissolving in water. Alternatively, suitable oxidizing agents can include peroxides or compounds that generate peroxides on reaction with water (for example, sodium perborate). Such oxidizing compounds can be present as a solid in a mixture of solids, in amounts appropriate to react with a bromine containing compound or salt to generate Br₂ in concentrations effective to control the growth of algae.

In a preferred embodiment, a composition of the inventive concept includes sodium bromide, sulfamic acid, and sodium tetraborate as a mixture of dry crystals or powders. In such an embodiment sodium bromide is present in at least about 2.5 fold molar excess over sulfamic acid, and in at least about 20 fold molar excess over sodium tetraborate. In an exemplary composition of the inventive concept, the molar ratios of sodium bromide:sulfamic acid:sodium tetraborate are about 1:0.33:0.06.

In some embodiments, the composition can include salts, for example a phosphate salt or a mixture of phosphate salts, that can act as pH buffers. Such buffer salts can be provided as dry crystals or powders that are mixed with sodium bromide, sulfamic acid, and sodium tetraborate. In such embodiments sodium bromide is present in at least about a 20 fold molar excess over a buffer salt. Suitable buffer salts include sodium hexametaphosphate, disodium phosphate, monosodium phosphate, trisodium phosphate, and/or tetrasodium phosphate. In an exemplary composition of the inventive concept the molar ratios of sodium bromide:sulfamic acid:sodium tetraborate:sodium hexametaphosphate:disodium phosphate:tetrasodium phosphate are about 1:0.33:0.06:0.02:0.03:0.01.

Compositions of the inventive concept can be provided as a liquid or as a solid (for example, a dry, granular mixture). Compositions of the inventive concept are effective in controlling or eliminating algae growth when added to enclosed bodies of water at low concentrations. A composition of the inventive concept can be effective in controlling algae growth in an enclosed body of water when added to provide a concentration of about 0.0004% (w/w) or greater of the composition. In a preferred embodiment of the inventive concept, the composition is supplied as a liquid solution, and is effective in controlling algae growth in an enclosed body of water at a concentration of at least about 0.00054% (w/w) in terms of dry ingredients of the composition.

In one example of a composition of the inventive concept a single, 3 gallon (11.4 L) batch of the algaecide composition includes 18 lbs (8.16 kg) of sodium bromide, 5.6 pounds (2.54 kg) of sulfamic acid, 30.7 ounces (870 g) of sodium hexametaphosphate, 11.5 ounces (326 g) of disodium phosphate, 5.8 ounces (164 g) of tetrasodium phosphate, and 2 pounds (907 g) of borax (sodium tetraborate).

Optionally, the composition can include a dye. For example, a blue dye can be provided in an amount sufficient to provide at least about 6 ounces (170 g) per 550 gallons (2082 L) of water treated by the algaecide composition.

As noted above, compositions of the inventive concept do not disrupt the chemistry of the pool water, and can be added as needed to control algae growth without pre-treatment or post-treatment testing of the water. An amount of the composition sufficient to provide a bromide concentration of at least about 0.5 ppm can be sufficient to provide adequate control of algae growth. In a preferred embodiment of the inventive concept, the composition can be used to provide a bromide concentration of about 2.5 to 10 ppm to control algae growth.

Compositions of the inventive concept can provide long term (i.e. greater than one week) control of the growth of unwanted algae in swimming pools and similar structures, with minimal or no negative impact on the water chemistry. The composition can be applied on a regular basis or on an as needed basis. In a preferred embodiment of the inventive concept, the composition can be applied as needed to reduce or eliminate algal growth in a swimming pool, hot tub, and/or spa without the need for testing of the water chemistry. For example, a user can typically apply the composition to their swimming pool without the need for testing of the water chemistry, simply on the basis of observing discoloration, haze, or other indicators of the growth of unwanted algae. It should be appreciated that addition of the composition to the enclosed body of water can have other beneficial effects, including control of pH and control, reduction, and/or elimination of scale buildup on pool or spa surfaces.

Another embodiment of the inventive concept is a method for controlling algae growth in an enclosed body of water, such as a swimming pool or spa. Algae growth can be considered controlled if it is reduced by about 50%, about 60%, about 70%, about 80% about 90%, about 95% or more relative to an untreated enclosed body of water under similar conditions. Elimination of algae growth can also be considered control of algae growth. It should be appreciated that, in doing so, other beneficial effects such as control of pH and control, reduction, and/or elimination of scale buildup on pool or spa surfaces can be realized. In such a method, a composition as described above is obtained, and then added as a dry mixture. The composition can be added directly to the body of water, or can be added to a filtration and/or heating system that is in fluid communication with the body of water. Similarly, the composition can be added as a single dose, multiple doses over a period of time, or continuously as a steady feed.

A user can add the composition to an enclosed body of water on a regular schedule in order to control or prevent the growth of unwanted algae. For example, a user can add the composition daily, every other day, three times a week, twice a week, weekly, twice a month, or monthly. In a preferred embodiment, a user can add the composition to an enclosed body of water once a week and achieve adequate control or prevention of algae growth,

Alternatively, in other embodiments a user can simply add an amount of the composition to the enclosed body of water on the observation of haze, water discoloration, water odor, or other indications of unwanted algae growth. In such an embodiment a user can either add a pre-determined amount of the composition to the enclosed body of water (for example, an amount that brings the bromide concentration into effective range as described above), or add doses repeatedly until adequate control or prevention of algae growth is observed. In such embodiments, adequate control or prevention of algae growth can be maintained for at least two days, at least a week, at least two weeks, or at least a month from the date of addition without further treatment. In a preferred embodiment, adequate control or prevention of algae growth is maintained for at least a week from the date of addition without the need for further treatment.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An algaecide composition, comprising:
a bromide salt;
sulfamic acid or a sulfamate salt; and,
a borate salt.

2. The algaecide composition of claim 1, wherein the bromide salt is present in at least a 2.5 fold molar excess over sulfamic acid or the sulfamate salt, and in at least a 20 fold molar excess over the borate salt.

3. The algaecide composition of claim 1, wherein the bromide salt is selected from the group consisting of sodium bromide, ammonium bromide, and potassium bromide.

4. The algaecide composition of claim 1, additionally comprising a sodium phosphate salt selected from the group consisting of sodium hexametaphosphate, disodium phosphate, and tetrasodium phosphate.

5. The algaecide composition of claim 1, further comprising an oxidizing agent.

6. The algaecide composition of claim 5, wherein the oxidizing agent is selected from the group consisting of ozone, chlorine, a hypochlorite containing salt, a dicholoroisocyanurate salt, dichloro-S-triazinetrione dihdrate, trichloro-S-triazinetrione, a peroxide, and a perborate salt.

7. The algaecide composition of claim 1, further comprising a colorant.

8. The algaecide composition of claim 7, wherein the colorant is a blue dye.

9. A method of controlling algae growth in an enclosed body of water, comprising:
obtaining an algaecide composition comprising a bromide salt, sulfamic acid or a sulfamate salt, and a borate salt; and
adding the algaecide composition to the enclosed body of water in an amount sufficient to provide an amount of bromide sufficient to control algae growth when dissolved in the enclosed body of water.

10. The method of claim 9, wherein algae growth is controlled for at least one week following the addition of the algaecide composition.

11. The method of claim 9, wherein the algaecide composition additionally comprises a colorant, and wherein an adequate treatment level is determined by observation of the colorant following dissolving of the algaecide composition.

12. The method of claim 9, further comprising adding an oxidizing agent to the enclosed body of water.

13. The method of claim 12, wherein the oxidizing agent is selected from the group consisting of ozone, chlorine, a hypochlorite containing salt, a dicholoroisocyanurate salt, dichloro-S-triazinetrione dihdrate, trichloro-S-triazinetrione, a peroxide, and a perborate salt.

14. The method of claim 9, wherein the addition of the algaecide composition additionally controls the buildup of scale.

15. The method of claim 9, wherein the body of water is a swimming pool.

16. The method of claim 9, wherein the body of water is a hot tub or spa.
